(19) United States
(12) Patent Application Publication
(10) Pub. No.: US 2012/0040678 A1
(43) Pub. Date: Feb. 16, 2012

(54) RADIO BASE STATION AND METHOD FOR CONTROLLING CONNECTION ESTABLISHMENT

(75) Inventors: Hirokazu Matsunami, Kanagawa (JP); Kyoko Fujito, Kanagawa (JP); Keiji Murakami, Kanagawa (JP)

(73) Assignee: KYOCERA CORPORATION, Kyoto (JP)

(21) Appl. No.: 13/265,912

(22) PCT Filed: Apr. 23, 2010
(86) PCT No.: PCT/JP2010/057294

§ 371 Date: Oct. 24, 2011

(30) Foreign Application Priority Data
Apr. 24, 2009 (JP) 2009-107091
Apr. 24, 2009 (JP) 2009-107094

(51) Int. Cl. H04W 36/00

(52) U.S. Cl. 455/436

(57) ABSTRACT

An LTE base station (10-1) transmits an SCTP-connection request message, which is a request to establish an X2 connection, to another LTE base stations which is a handover target, when executing a handover.

### TECHNICAL FIELD

The present invention relates to a radio base station configured to establish a first connection which is a logical transmission path with a higher network and a second connection which is a logical transmission path with a different radio base station, and to a method for controlling connection establishment in the radio base station.

### BACKGROUND ART

A radio communication system such as LTE (Long Term Evolution) whose specifications are currently developed in the 3GPP (Third Generation Partnership Project) requires not only an S1 connection but also an X2 connection in order to achieve a quick handover, reduction of processing load on the core network, and the like. The S1 connection is a logical transmission path between a core network and radio base stations (hereinafter, referred to as “LTE base stations”), and the X2 connection is a logical transmission path between the radio base stations.

In order to establish the X2 connection, an LTE base station acquires information on neighboring different LTE base stations and holds a list of neighbor base-stations (hereinafter, referred to as a neighbor list) which is a list of the information on the different LTE base stations. The neighboring different LTE base stations means different LTE base stations in a short distance from the LTE base station. Holding the neighbor list by the LTE base station enables establishment of an X2 connection, load distribution among LTE base stations, and control of regulation and the like in maintenance operations.

The LTE base station can request a radio terminal for a handover based on measurement reports from the radio terminal. The measurement reports include information on IDs of LTE base stations which are transmission sources of signals (BCH signals) received by the radio terminal through broadcast channels (BCHs), field intensities of the signals, and the like. The LTE base station can identify an LTE base station to be a handover target based on the information on the IDs and the field intensities included in the measurement reports, and instructs the radio terminal to perform the handover at appropriate timing.

An ANR (Automatic Neighbour Relation Function) is considered to be employed as a method for an LTE base station to acquire information on the neighboring different LTE base stations. ANR is a method in which measurement reports generated regularly or every event are received from the radio terminal (for example, see Non-Patent Document 1).

In addition, the LTE radio communication system is provided with a data forwarding function so as to achieve a handover with less packet loss. The data forwarding function is a function of forwarding, by the LTE base station, data left untransmitted to the radio terminal immediately before a handover, to a handover target LTE base station through an X2 connection. The handover target LTE base station transmits the data, received through the X2 connection, through a radio channel to the radio terminal newly connected by the handover. This can prevent the packet loss at the handover.

The LTE radio communication system has specifications of: a handover (hereinafter, referred to as an “X2 handover”) in which the data forwarding is executed through the aforementioned X2 connection; and a handover (hereinafter, referred to as an “S1 handover”) in which the data forwarding is executed through an S1 connection. Which one of the X2 handover and the S1 handover is used generally depends on whether or not an X2 connection is established. That is, when an X2 connection is established between LTE base stations, the X2 handover is executed. However, the handover selection criterion is a matter to be designed by the vendor as appropriate.

Establishment of the X2 connection is set by a maintenance person in advance or set in OAM (Operation and Maintenance). In either case, the establishment of the X2 connection is executed, when the LTE base station is started.

### PRIOR ART DOCUMENT

### Non-Patent Document

NON-PATENT DOCUMENT 1: “3GPP TS 36.300 V8.5.0 (2008-05),” [online], [Searched on Apr. 13, 2009], URL:http://www.arib.or.jp/IMT-2000/V700Sep08/5_Appendix/R el8/36/36300-850.pdf

### SUMMARY OF INVENTION

However, in the case where the establishment of the X2 connection is set by the maintenance person in advance or is set in OAM, and is executed at the time of starting the LTE base station, the X2 connection is fixedly established during operations of the LTE base station without consideration of past records of handovers. For this reason, there is a possibility that an X2 connection not to be used for a handover, in other words, an unnecessary X2 connection is established.

Meanwhile, in order to update the X2 connection as needed during the operations of the LTE base station, a method is conceived by which the LTE base station establishes an X2 connection with a different LTE base station identified by an ID included in a measurement report. However, in such a measurement-report-based method, the LTE base station only establishes an X2 connection with a different LTE base station which is a prospective handover target, without consideration of past records of handovers. Thus, also the measurement-report-based method has a possibility that an unnecessary X2 connection is established.

In view of the aforementioned problems, an objective of the present invention is to provide a radio base station capable of establishing an appropriate connection with a different radio base station and a method for controlling connection establishment.

In order to solve the problems mentioned above, this invention has the following features. According to a first feature of this invention, there is provided a radio base station (LTE base stations 10-1 to 10-3) capable of establishing a first connection (S1 connection) which is a logical transmission path with a higher network and a second connection (X2 connection) which is a logical transmission path with a different radio base station, the radio base station comprising: a transmitter (connection establishment processing execution unit 154) configured to transmit a request message for establishing the second connection, to the different radio base station which is a handover target or a handover source, wherein, when the radio base station executes a handover, the transmitter transmits the request message.

When executing the handover, the above radio base station transmits the request message for establishing the second connection to the radio base station which is the handover target or the handover source. Thus, the second connection can be established with past records of the handovers taken into consideration, and an unnecessary connection is prevented from being established with any one of the different radio base stations.

A second feature of the present invention is according to the first feature of the present invention and is summarized in that the transmitter transmits the request message when the second connection is not established with the different radio base station which is the handover target or the handover source.

A third feature of the present invention is according to the second feature of the present invention and is summarized in that the radio base station further comprises a holding unit (storage unit 103) configured to hold information on the different radio base station, wherein, based on the information on the different radio base station held in the holding unit, the transmitter determines whether or not the second connection is established with the different radio base station which is the handover target or the handover source.

A fourth feature of the present invention is according to the third feature of the present invention and is summarized in that the information on the different radio base station includes identification information of the different radio base station.

A fifth feature of the present invention is according to one of the first to fourth features of the present invention and is summarized in that the transmitter transmits the request message when the handover of a radio terminal is completed.

A sixth feature of the present invention is according to one of the first to fourth features of the present invention and is summarized in that the radio base station further comprising a storage unit (storage unit 103) configured to store identification information of a different radio base station which has been a handover target at a handover where the radio base station itself has been a handover source in the past, and store establishment information indicating whether or not the second connection is established between the radio base station itself and the different radio base station of the handover target.

According to a seventh feature of the present invention, there is provided a connection establishment control method in a radio base station capable of establishing a first connection which is a logical transmission path with a higher network and a second connection which is a logical transmission path with a different radio base station, the connection establishment control method comprising the step of transmitting a request message for establishing the second connection, from the radio base station to the different radio base station which is a handover target or a handover source, when the radio base station executes a handover.

According to an eighth feature of the present invention, there is provided a radio base station (LTE base stations 10-1 to 10-3) capable of establishing a first connection (S1 connection) which is a logical transmission path with a higher network and a second connection (X2 connection) which is a logical transmission path with any one of different radio base stations, the radio base station comprising: a connection changing unit (connection changing unit 158) configured to control release and/or re-establishment of the second connection with the different radio base station based on the number of handovers involving the different radio base station.

Each of the radio base stations as described above releases and re-establishes the second connection with any one of the different radio base stations based on the number of handovers involving the different radio base station. Thus, it is possible to establish an appropriate connection with the different radio base station in the following manner or the like. When having a small number of handovers involving the different radio base station, the radio base station releases the second connection with the different radio base station. In addition, when having a large number of handovers involving the different radio base station, the radio base station re-establishes the second connection with the different radio base station.

A ninth feature of the present invention is according to the eighth feature of the present invention and is summarized in that the number of handovers is the number of handovers between the radio base station itself and the different radio base station and/or the number of past handovers of a radio terminal to the radio base station itself as a handover target.

A tenth feature of the present invention is according to the eighth feature or the ninth feature of the present invention and is summarized in that the connection changing unit releases the second connections with a predetermined first number of radio base stations in ascending order of priority determined according to the number of handovers, among the different radio base stations.

An eleventh feature of the present invention is according to the tenth feature of the present invention and is summarized in that the connection changing unit releases the second connection in at least one of cases where load on a network between the radio base station itself and the different radio base stations is equal to or higher than a first predetermined value, where load on the radio base station itself is equal to or higher than a second predetermined value, and where load on the different radio base stations is equal to or higher than a third predetermined value.

A twelfth feature of the present invention is according to the eighth feature of the present invention and is summarized in that the connection changing unit re-establishes the second connections with a predetermined second number of radio base stations in descending order of priority determined according to the number of handovers, among the different radio base stations.

A thirteenth feature of the present invention is according to the twelfth feature of the present invention and is summarized in that the connection changing unit re-establishes the second connection in at least one of cases where load on a network between the radio base station itself and the different radio base stations is equal to or lower than a fourth predetermined value, where load on the radio base station itself is equal to or lower than a fifth predetermined value, and where load on the different radio base stations is equal to or lower than a sixth predetermined value.

According to a fourteenth feature of the present invention, there is provided a connection establishment control method in a radio base station capable of establishing a first connection which is a logical transmission path with a higher network and a second connection which is a logical transmission path with any one of different radio base stations, the connection establishment control method comprising the steps of: acquiring, by the radio base station, the number of handovers involving the different radio base station; and controlling, by the radio base station, release and/or re-establishment of the second connection with the different radio base station, on the basis of the acquired number of handovers.

The present invention makes it possible to establish an appropriate connection with a different radio base station.

### BRIEF DESCRIPTION OF DRAWINGS

FIG. 1 is an overall schematic configuration diagram of a radio communication system according to an embodiment of the present invention.

FIG. 2 is a diagram showing an establishment state of S1 connections in the radio communication system according to the embodiment of the present invention.

FIG. 3 is a configuration diagram of an LTE base station according to the embodiment of the present invention.

FIG. 4 is a chart showing a first measurement report from a radio terminal according to the embodiment of the present invention.

FIG. 5 is a chart showing a second measurement report from the radio terminal according to the embodiment of the present invention.

FIG. 6 is a chart showing an example of a neighbor list according to the embodiment of the present invention.

FIG. 7 is a diagram showing a first establishment state of X2 connections in the radio communication system according to the embodiment of the present invention.

FIG. 8 is a chart showing an example of a neighbor base-station priority table according to the embodiment of the present invention.

FIG. 9 is a diagram showing a second establishment state of the X2 connections in the radio communication system according to the embodiment of the present invention.

FIG. 10 is a flowchart showing an operation of controlling X2 connection establishment by the LTE base station according to the embodiment of the present invention.

FIG. 11 is a flowchart showing an operation of acquiring the number of handovers by the LTE base station according to the embodiment of the present invention.

FIG. 12 is a flowchart showing an operation of controlling X2 connection release by the LTE base station according to the embodiment of the present invention.

FIG. 13 is a flowchart showing an operation of controlling X2 connection re-establishment by the LTE base station according to the embodiment of the present invention.

### DESCRIPTION OF EMBODIMENTS

Next, a description is given of an embodiment of the present invention by referring to the drawings. Specifically, descriptions are given of (1) Schematic Configuration of Radio Communication System, (2) Configuration of LTE Base Station, (3) Operation of LTE Base Station, (4) Advantageous Effects, and (5) Other Embodiment. Note that, in the following description of the drawings, same or similar reference numerals denote same or similar elements and portions.

### (1) Schematic Configuration of Radio Communication System

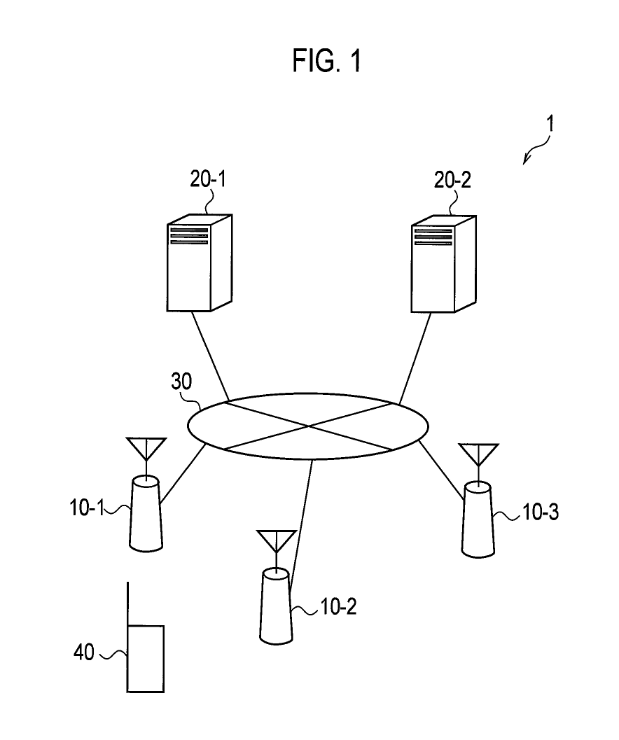

FIG. 1 is a schematic configuration diagram of a radio communication system according to this embodiment. In this embodiment, a radio communication system 1 is configured by using an LTE technique. The radio communication system 1 includes: radio base stations (LTE base stations) 10-1, 10-2, and 10-3; MMEs (Mobile Management Entities)/SGWs (Serving Gateways) 20-1 and 20-2 which are forward controllers provided in a core network as a higher network; a backbone network 30; and a radio terminal 40.

In an initial state, only S1 connections which are logical transmission paths of a transport layer are established between the LTE base stations 10-1 to 10-3 and the MMEs/SGWs 20-1 and 20-2 through the backbone network 30.

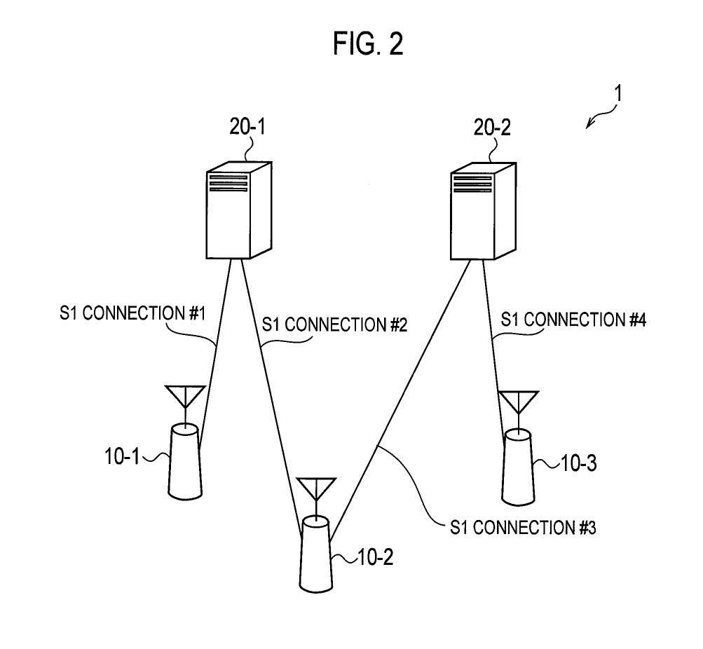

FIG. 2 is a diagram showing an establishment state of the S1 connections in the initial state in the radio communication system 1. In FIG. 2, an S1 connection #1 is established between the LTE base station 10-1 and the MME/SGW 20-1. In addition, an S1 connection #2 is established between the LTE base station 10-2 and the MME/SGW 20-1, and an S1 connection #3 is established between the LTE base station 10-2 and the MME/SGW 20-2. Moreover, an S1 connection #4 is established between the LTE base station 10-3 and the MME/SGW 20-2. Note that further, an S1 connection may be established between the LTE base station 10-1 and the MME/SGW 20-2, and an S1 connection may be established between the LIE base station 10-3 and the MME/SGW 20-1.

Radio communications are performed between the LTE base stations 10-1 to 10-3 and the radio terminal 40 through radio communication sections. In LTE, a communication scheme used between the LTE base stations 10-1 to 10-3 and the radio terminal 40 is referred to as E-UTRAN (Evolved UMTS Terrestrial Radio Access Network).

### (2) Configuration of LTE Base Station

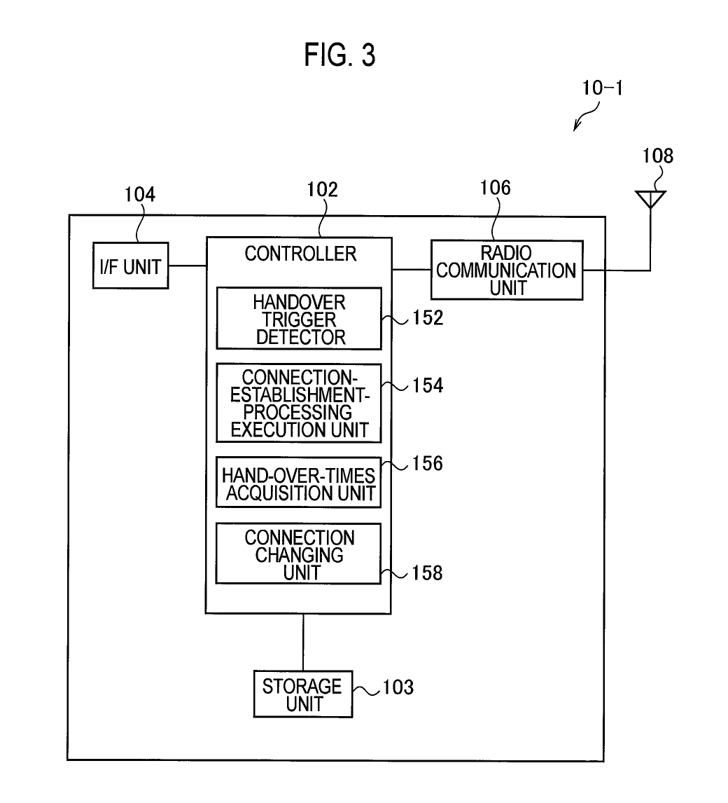

FIG. 3 is a diagram showing a configuration of each of the LTE base stations. The LTE base station 10-1 shown in FIG. 2 includes a controller 102, a storage unit 103, an I/F unit 104, a radio communication unit 106, and an antenna 108. Note that the LTE base stations 10-2 and 10-3 each have the same configuration as that of the LTE base station 10-1.

The controller 102 includes a CPU, for example, and controls various functions provided for the LTE base station 10-1 which is its own LTE base station. The storage unit 103 includes a memory, for example, stores various information used for control and the like by the LTE base station 10-1.

The I/F unit 104 is connected to the backbone network 30. The radio communication unit 106 includes an RF circuit, a baseband circuit, and the like, performs modulation and demodulation, coding and decoding, and the like, and transmits and receives radio signals from and to the radio terminal 40 through the antenna 108.

The controller 102 includes a handover trigger detector 152, a connection-establishment-processing execution unit 154, a hand-over-times acquisition unit 156, and a connection changing unit 158.

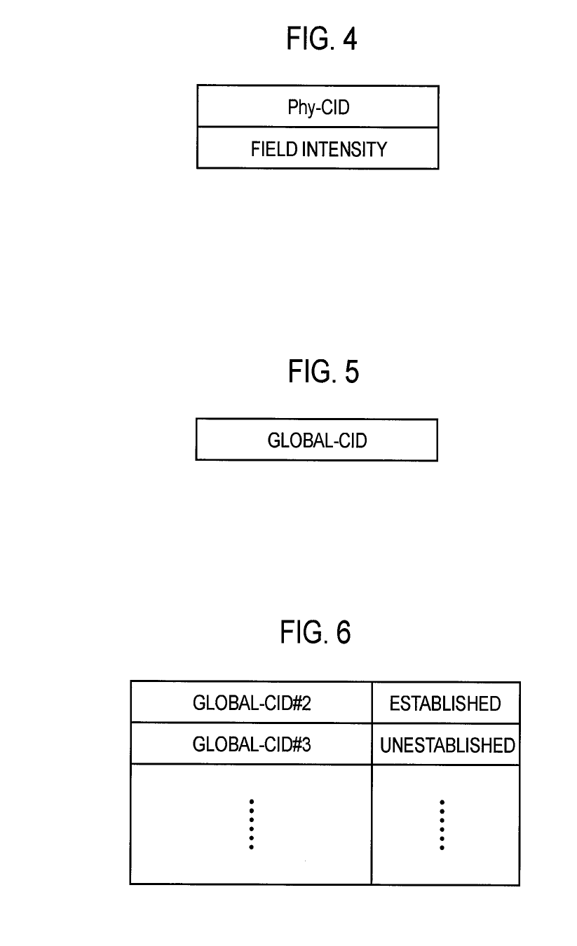

The radio terminal 40 receives broadcast control channel (BCH) signals from neighboring LTE base stations. Each of the BCH signals includes: a physical ID (Phy-CID) which is identification information of an LTE base station as a transmission source; and a global ID (Global-CID) thereof. Next, the radio terminal 40 measures the field intensity of the BCH signal. Further, the radio terminal 40 generates and transmits a measurement report including the Phy-CID and the field strength. FIG. 4 is a chart showing a first measurement report from the radio terminal 40.

The handover trigger detector 152 receives the first measurement report from the radio terminal 40 performing radio communication with the LTE base station 10-1, through the antenna 108 and the radio communication unit 106.

Next, the handover trigger detector 152 sends the radio terminal 40 a request message for the Global-CID corresponding to the Phy-CID of the different LTE base station included in the first measurement report through the radio communication unit 106 and the antenna 108. The Global-CID request message includes the Phy-CID of the different LTE base station.

Upon receipt of the Global-CID request message, the radio terminal 40 identifies the Global-CID of the different LTE base station based on the Phy-CID of the different LTE base station included in the Global-CID request message. Further, the radio terminal 40 transmits the Global-CID of the different LTE base station to the LTE base station 10-1. FIG. 5 is a chart showing a Global-CID which is a second measurement report from the radio terminal 40.

The handover trigger detector 152 receives the Global-CID of the different LTE base station from the radio terminal 40 through the antenna 108 and the radio communication unit 106.

Next, the handover trigger detector 152 determines whether or not the field strength corresponding to the LTE base station 10-1 included in one for itself of the first measurement reports, in other words, the field strength, at the radio terminal 40, of the BCH signal transmitted by the LTE base station 10-1 is equal to or lower than a first threshold. Further, the handover trigger detector 152 determines whether or not the field strength corresponding to any one of the LTE base stations (different LTE base stations) other than the LTE base station 10-1 which is its own LTE base station is equal to or higher than a second threshold, the different LTE base station being included in corresponding first measurement reports.

If the field strength corresponding to the LTE base station 10-1 is equal to or lower than the first threshold and if the field strength corresponding to the different LTE base station is equal to or higher than the second threshold, the handover trigger detector 152 determines that the radio terminal 40 reaches trigger timing of a handover from the LTE base station 10-1 to the different LTE base station.

When the radio terminal 40 reaches the trigger timing of the handover, the controller 102 sends the radio terminal 40 an RRC Connection Reconfiguration Message for executing the handover from the LTE base station 10-1 to the different LTE base station, through the radio communication unit 106 and the antenna 108. The RRC Connection Reconfiguration Message includes a Global-CID of the different LTE base station which is a handover target. Upon receipt of the RRC Connection Reconfiguration Message, the radio terminal 40 executes handover processing to be performed on the radio terminal 40 (processing of a handover from the LTE base station 10-1 to the different LTE base station) on the basis of the RRC Connection Reconfiguration Message.

Next, the connection-establishment-processing execution unit 154 determines whether or not the handover from the LTE base station 10-1 to the different LTE base station allows a handover (an X2 handover) in which the data forwarding is executed through an X2 connection being a logical transfer path in the transport layer.

Specifically, the connection-establishment-processing execution unit 154 reads a neighbor list stored in the storage unit 103. FIG. 6 is a chart showing an example of the neighbor list. The neighbor list shown in FIG. 6 includes: Global-CIDs of different LTE base stations which have been handover targets at handovers where the LTE base station 10-1 has been a handover source in the past; and X2 connection establishment information indicating whether or not an X2 connection is established between the LTE base station 10-1 and the handover-target different LTE base stations.

If the neighbor list includes the Global-CID of the different LTE base station which is the handover target of the current handover and if X2 connection establishment information corresponding to the Global-CID of the handover-target different LTE base station is “established,” the connection-establishment-processing execution unit 154 determines that the X2 connection is established between the LTE base station 10-1 and the handover-target different LTE base station, and thus that an X2 handover is possible.

On the other hand, if the neighbor list does not include the Global-CID of the handover-target different LTE base station, the connection-establishment-processing execution unit 154 determines that the X2 connection is not established between the LTE base station 10-1 and the handover-target different LTE base station, and thus that the X2 handover is impossible.

In addition, if the neighbor list includes the Global-CID of the handover-target different LTE base station but if X2 connection establishment information corresponding to the Global-CID of the handover-target different LTE base station is “unestablished,” the connection-establishment-processing execution unit 154 determines that the X2 connection is not established between the LTE base station 10-1 and the handover-target different LTE base station, and thus that the X2 handover is impossible.

If the X2 connection is established between the LTE base station 10-1 and the handover-tar get different LTE base station, the controller 102 performs the X2 handover at which the data forwarding is executed through the X2 connection. Specifically, the controller 102 forwards data left untransmitted to the radio terminal 40, to the handover-target different LTE base station through the X2 connection.

On the other hand, if the X2 connection is not established between the LTE base station 10-1 and the handover-target different LTE base station, the connection-establishment-processing execution unit 154 adds the Global-CID of the handover-target different LTE base station to the neighbor list and sets corresponding X2 connection establishment information to “unestablished” therein.

Further, the controller 102 performs an S1 handover and executes the data forwarding through an S1 connection to forward data left untransmitted to the radio terminal 40, to the handover-target different LTE base station through the I/F unit 104 and the S1 connection.

After the X2 handover or the S1 handover as described above, the connection-establishment-processing execution unit 154 determines whether or not there is a different LTE base station which has no established X2 connection with the LTE base station 10-1 in the neighbor list. Specifically, if “unestablished” is shown in certain X2 connection establishment information, the connection-establishment-processing execution unit 154 determines that a different LTE base station identified by a Global-CID corresponding to the X2 connection establishment information is a different LTE base station which has no established X2 connection with the LTE base station 10-1.

If there is a different LTE base station which has no established X2 connection with the LTE base station 10-1 in the neighbor list, the connection-establishment-processing execution unit 154 generates an SCTP (Stream Control Transmission Protocol) connection request message which is a request for establishing an X2 connection. Further, the connection-establishment-processing execution unit 154 transmits the SCTP connection request message to the different LTE base station which has no established X2 connection with the LTE base station 10-1, through the I/F unit 104 and the backbone network 30.

Thereafter, an X2 connection is established between the LTE base station 10-1 and the different LTE base station receiving the SCTP connection request message.

Still further, the connection-establishment-processing execution unit 154 updates the X2 connection establishment information in the neighbor list corresponding to the Global-CID of the different LTE base station to which the SCTP connection request message is transmitted, from “unestablished” to “established.”

As described above, after a state in which only the S1 connections are established in the initial state, an X2 connection is established between the LTE base stations in accordance with trigger timing of a subsequent handover.

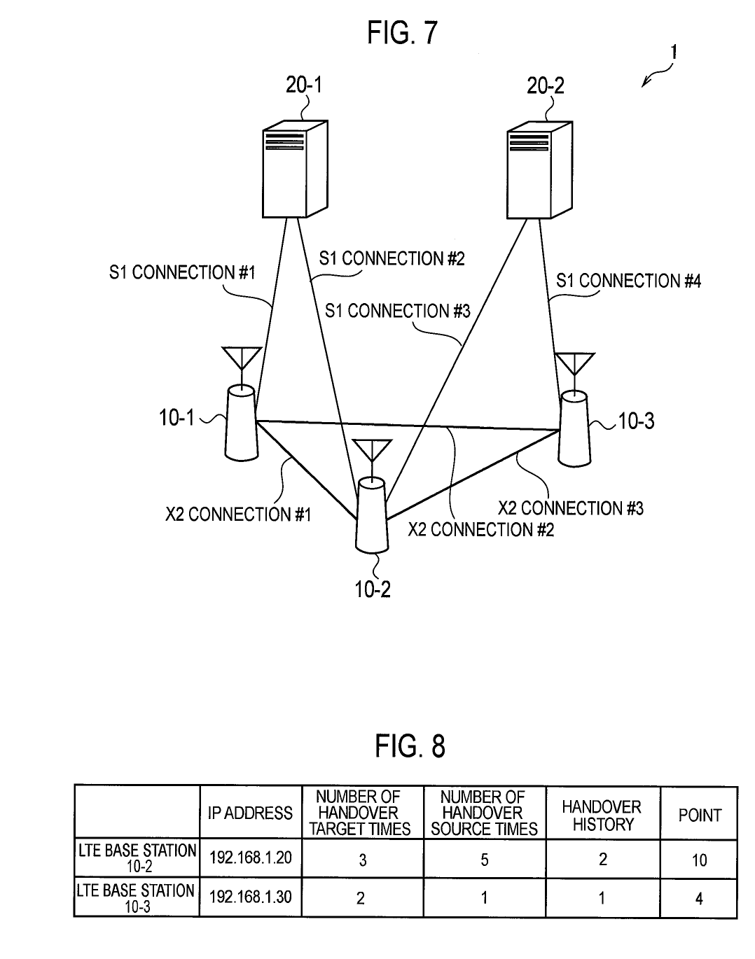

FIG. 7 is a diagram showing an establishment state of the X2 connections in the radio communication system 1. As shown in FIG. 7, when triggered for a handover between the LTE base station 10-1 and the LTE base station 10-2, an X2 connection #1 is thereby established between the LTE base station 10-1 and the LTE base station 10-2. Moreover, when triggered for a handover between the LTE base station 10-1 and the LTE base station 10-3, an X2 connection #2 is thereby established between the LTE base station 10-1 and the LTE base station 10-3. Furthermore, when triggered for a handover between the LTE base station 10-2 and the LTE base station 10-3, an X2 connection #3 is thereby established between the LTE base station 10-2 and the LTE base station 10-3.

The description is still given by referring back again to FIG. 3. The hand-over-times acquisition unit 156 acquires the number of handovers involving the different LTE base stations.

Specifically, at a handover performed when one of the different LTE base stations is a handover source and the LTE base station 10-1 is a handover target, the hand-over-times acquisition unit 156 receives a handover request message transmitted from the radio terminal 40 through the antenna 108 and the radio communication unit 106.

Next, the hand-over-times acquisition unit 156 extracts a UE History information element included in the received handover request message. The UE History information element includes Global-CIDs of LTE base stations connected in the past with the radio terminal 40 which has transmitted the handover request message, the Global-CIDs being referred to as last Visited Cell Information. Note that when the radio terminal 40 has been connected with the same LTE base station multiple times in the past, the History information element includes the same Global-CIDs the number of which corresponds to the connection times of the LTE base station.

In addition, at the handover performed when the different LTE base station is a handover source and the LTE base station 10-1 is a handover target, the hand-over-times acquisition unit 156 recognizes that one handover occurs. In addition, at a handover performed when the LTE base station 10-1 is a handover source and the different LTE base station is a handover target, the hand-over-times acquisition unit 156 recognizes that one handover occurs.

Further, the hand-over-times acquisition unit 156 generates and updates a neighbor base-station priority table. FIG. 8 is a chart showing an example of the neighbor base-station priority table. The neighbor base-station priority table shown in FIG. 8 has records formed on a different LTE base station basis and is stored in the storage unit 103. Information in the neighbor base-station priority table may be included in the neighbor list. The records are each formed by a Global-CID of a corresponding one of the different LTE base stations, an IP address thereof, the number of handover target times, the number of handover source times, a handover history, and a point.

The IP address is an IP address as identification information of the corresponding different LTE base station.

The number of handover target times shows the number of handovers at which the LTE base station 10-1 is a handover source and the corresponding different LTE base station is a handover target. The hand-over-times acquisition unit 156 increments the number of handover target times by one every time an occurrence of the handover is recognized at which the LTE base station 10-1 is a handover source and the corresponding different LTE base station is a handover target.

The number of handover source times shows the number of handovers at which the corresponding different LTE base station is a handover source and the LTE base station 10-1 is a handover target. The hand-over-times acquisition unit 156 increments the number of handover source times by one every time an occurrence of the handover is recognized at which the corresponding different LTE base station is a handover source and the LTE base station 10-1 is a handover target.

The handover history shows how many times the corresponding different LTE base station has served as a connection target of the radio terminal 40 in the past. Every time the handover occurs at which the corresponding different LTE base station is a handover source and the LTE base station 10-1 is a handover target, the hand-over-times acquisition unit 156 increments a value of the handover history by the number of Global-CIDs of the corresponding different LTE base station, which are included in the Global-CIDs included in the UE History information element in the handover request message from the radio terminal 40.

The point is a total value of the number of handover target times, the number of handover source times, and the handover history. Every time the hand-over-times acquisition unit 156 updates the number of handover target times, the number of handover source times, or the handover history, the hand-over-times acquisition unit 156 updates the point as well. Note that the hand-over-times acquisition unit 156 may weight the number of handover target times, the number of handover source times, and the handover history, as appropriate. In this case, a total value of the number of handover target times, the number of handover source times, and the handover history which are weighted becomes the point.

The description is still given by referring back again to FIG. 3. The connection changing unit 158 detects load on the backbone network 30 and load on the LTE base station 10-1 which is its own LTE base station. The load on the backbone network 30 is expressed as an amount of data transmitted in the backbone network 30, for example. Through the I/F unit 104, the connection changing unit 158 receives information on the load on the backbone network 30 transmitted from the backbone network 30. In contrast, the load on the LTE base station 10-1 is expressed, for example, as an activity ratio of the CPU included in the controller 102.

Further, the connection changing unit 158 determines whether or not the load on the backbone network 30 is equal to or higher than a predetermined value α1 and determines whether or not the load on the LTE base station 10-1 is equal to or higher than a predetermined value β1.

If any one of conditions that the load on the backbone network 30 is equal to or higher than the predetermined value α1 and that the load on the LTE base station 10-1 is equal to or higher than the predetermined value β1 is satisfied, the connection changing unit 158 determines whether or not there is one or more different LTE base stations which have respective established X2 connections with the LTE base station 10-1.

Specifically, the connection changing unit 158 refers to the X2 connection establishment information in the neighbor list. Further, if there is X2 connection establishment information indicating “established,” the connection changing unit 158 determines that there is one or more different LTE base stations which have respective established X2 connections with the LTE base station 10-1.

If there is one or more different LTE base stations which have respective established X2 connections with the LTE base station 10-1, the connection changing unit 158 identifies a different LTE base station assigned the lowest priority among the different LTE base stations which have respective established X2 connections with the LTE base station 10-1, on the basis of the neighbor base-station priority table.

Specifically, the connection changing unit 158 identifies Global-CIDs corresponding to X2 connection establishment information showing “established” in the neighbor list. Next, the connection changing unit 158 extracts records including the identified Global-CIDs from records in the neighbor base-station priority table. Further, the connection changing unit 158 compares points of the extracted records with each other and identifies a record having the lowest point. Note that the identified record is a record corresponding to the different LTE base station assigned the lowest priority among the different LTE base stations which have respective established X2 connections with the LTE base station 10-1.

Further, the connection changing unit 158 generates a SCTP release request message which is a request for releasing the X2 connection and which is addressed to the Global-CID in the record corresponding to the different LTE base station assigned the lowest priority. Still further, the connection changing unit 158 transmits the SCTP release request message to the different LTE base station through the I/F unit 104 and the backbone network 30.

Subsequently, the X2 connection is released between the LTE base station 10-1 and the different LTE base station receiving the SCTP release request message.

Further, the connection changing unit 158 updates the X2 connection establishment information in the neighbor list corresponding to the Global-CID of the different LTE base station to which the SCTP release request message is transmitted, from “established” to “unestablished.”

As described above, if the load on the backbone network 30 is equal to or higher than the predetermined value α1, or if the load on the LTE base station 10-1 is equal to or higher than the predetermined value β1, released is the X2 connection of the different LTE base station assigned the lowest priority among the different LTE base stations which have respective established X2 connections with the LTE base station 10-1.

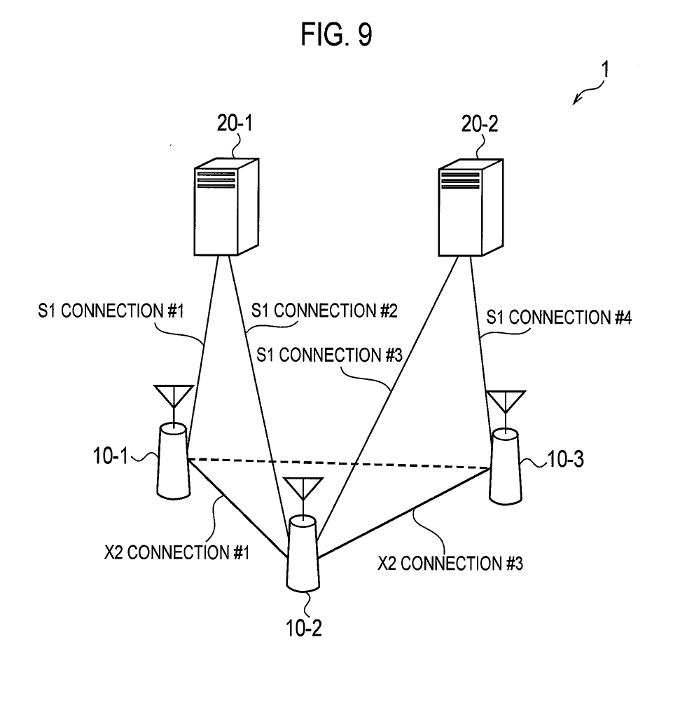

FIG. 9 is a diagram showing a case where an X2 connection is released, which is established with the LTE base station 10-3 assigned the lowest priority in the LTE base stations 10-2 and 10-3 which have respective established X2 connections with the LTE base station 10-1.

The description is still given by referring back again to FIG. 3. After the aforementioned release of the X2 connection, the connection changing unit 158 again detects load on the backbone network 30 and load of the LTE base station 10-1 which is its own LTE base station. Moreover, the connection changing unit 158 determines whether or not the load on the backbone network 30 is equal to or lower than a predetermined value α2 (however, α2≦α1) and determines whether or not the load on the LTE base station 10-1 is equal to or lower than a predetermined value β2 (however, β2≦β1).

If any one of conditions that the load on the backbone network 30 is equal to or lower than the predetermined value α2 and that the load on the LTE base station 10-1 is equal to or lower than the predetermined value β2 is satisfied, the connection changing unit 158 determines whether or not there is one or more different LTE base stations which have no established X2 connections with the LTE base station 10-1.

Specifically, the connection changing unit 158 refers to the X2 connection establishment information in the neighbor list. Further, if there is X2 connection establishment information indicating “unestablished,” the connection changing unit 158 determines that one or more different LTE base stations which have no established X2 connections with the LTE base station 10-1.

If there is one or more different LTE base stations which have no established X2 connections with the LTE base station 10-1, the connection changing unit 158 identifies a different LTE base station assigned the highest priority among the different LTE base stations which have no established X2 connections with the LTE base station 10-1, on the basis of the neighbor base-station priority table.

Specifically, the connection changing unit 158 identifies Global-CIDs corresponding to X2 connection establishment information indicating “unestablished” in the neighbor list. Next, the connection changing unit 158 extracts records including the identified Global-CIDs from records in the neighbor base-station priority table. Further, the connection changing unit 158 compares points of the extracted records with each other and identifies a record having the highest point. Note that the identified record is a record corresponding to the different LTE base station assigned the highest priority among the different LTE base stations which have no established X2 connections with the LTE base station 10-1.

Further, the connection changing unit 158 generates a SCTP connection request message which indicates a request for establishing the X2 connection and which is addressed to the Global-CID in the record corresponding to the different LTE base station assigned the highest priority. Still further, the connection changing unit 158 transmits the SCTP connection request message to the different LTE base station through the I/F unit 104 and the backbone network 30.

Subsequently, the X2 connection is re-established between the LTE base station 10-1 and the different LTE base station receiving the SCTP connection request message.

Further, the connection changing unit 158 updates the X2 connection establishment information in the neighbor list corresponding to the Global-CID of the different LTE base station to which the SCTP connection request message is transmitted, from “unestablished” to “established.”

As described above, if the load on the backbone network 30 is equal to or lower than the predetermined value α2, or if the load on the LTE base station 10-1 is equal to or lower than the predetermined value β2, re-established is an X2 connection of the different LTE base station assigned the highest priority among the different LTE base stations which have no established X2 connections with the LTE base station 10-1.

### (3) Operation of LTE Base Station

Next, a description is given of an operation of the LTE base station 10-1. Note that the LTE base stations 10-2 and 10-3 perform the same operation as that of the LTE base station 10-1.

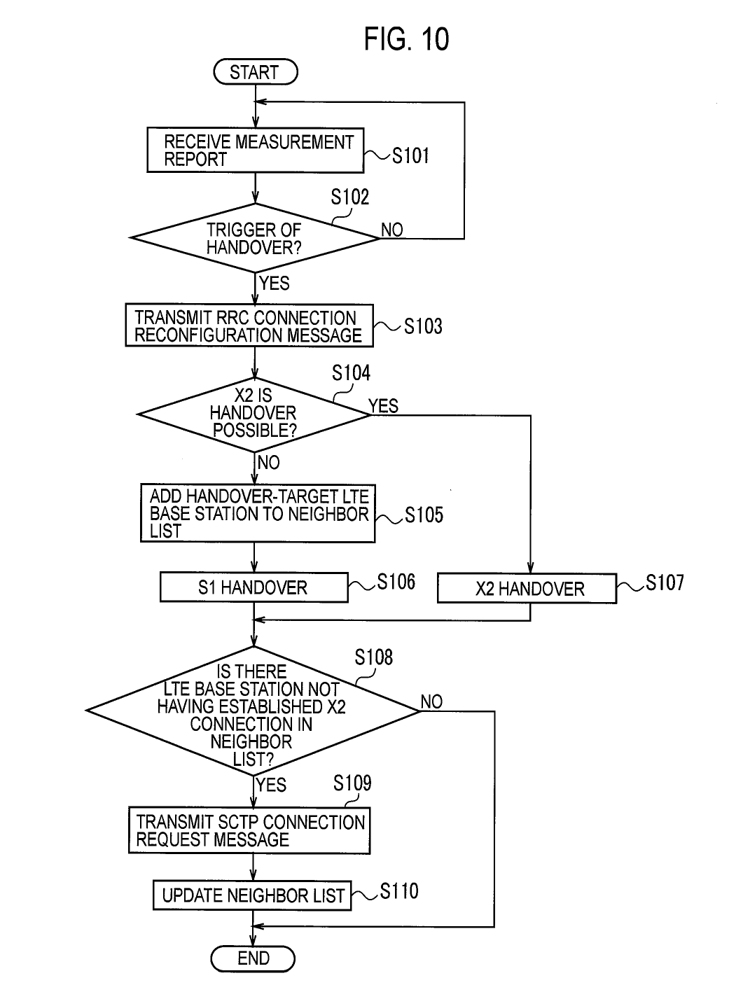

FIG. 10 is a flowchart showing an operation of controlling X2 connection establishment by the LTE base station 10-1.

In Step S101, the handover trigger detector 152 in the controller 102 receives a measurement report from the radio terminal 40 performing radio communication with the LTE base station 10-1.

In Step S102, the handover trigger detector 152 in the controller 102 determines whether or not the radio terminal 40 which transmits the measurement report reaches trigger timing of a handover, on the basis of the measurement report.

When the radio terminal 40 reaches the trigger timing of a handover (when the LTE base station 10-1 is to execute a handover), in Step S103 the controller 102 transmits an RRC Connection Reconfiguration Message to the radio terminal 40.

In Step S104, based on the neighbor list, the connection-establishment-processing execution unit 154 in the controller 102 determines whether or not an X2 handover is possible at a handover from the LTE base station 10-1 to one of the different LTE base stations.

If the X2 handover is determined to be impossible, in Step S105 the connection-establishment-processing execution unit 154 adds a Global-CID of the handover-target different LTE base station to the neighbor list and sets corresponding X2 connection establishment information to “unestablished.”

Further, in Step S106, the controller 102 performs an S1 handover at which data forwarding is executed through an S1 connection.

On the other hand, if the X2 handover is determined to be possible in Step S104, in Step S107 the controller 102 performs an X2 handover at which data forwarding is executed through an X2 connection.

After the S1 handover in Step S106, or after the X2 handover in Step S107, the connection-establishment-processing execution unit 154 determines in Step S108 whether or not there is a different LTE base station in the neighbor list which has no established X2 connection with the LTE base station 10-1.

If there is no different LTE base station which has no established X2 connection with the LTE base station 10-1, a series of operations ends.

On the other hand, if there is a different LTE base station which has no established X2 connection with the LTE base station 10-1, the connection-establishment-processing execution unit 154 generates a SCTP connection request message showing a request for establishing a X2 connection and transmits the SCTP connection request message to the different LTE base station which has no established X2 connection with the LTE base station 10-1.

In Step S110, the connection-establishment-processing execution unit 154 updates the X2 connection establishment information in the neighbor list corresponding to a Global-CID of the different LTE base station to which the SCTP connection request message is transmitted, from “unestablished” to “established.”

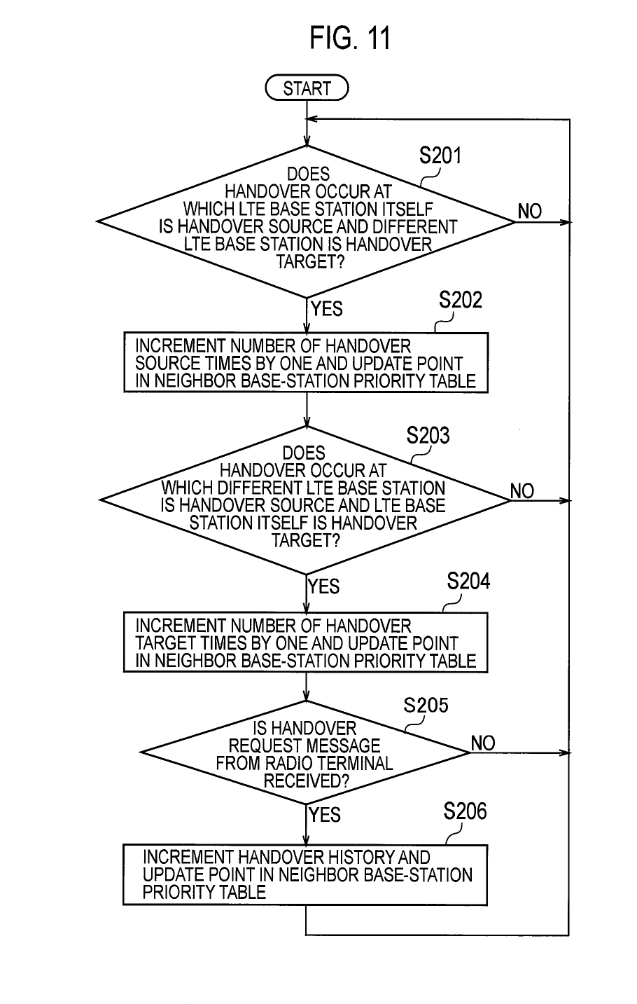

After the operation of controlling X2 connection establishment shown in FIG. 10, an operation of acquiring the number of handovers is performed. FIG. 11 is a flowchart showing the operation of acquiring the number of handovers by the LTE base station 10-1.

In Step S201, the hand-over-times acquisition unit 156 in the controller 102 determines whether or not a handover occurs at which the LTE base station 10-1 as its own LTE base station is a handover source and one of the different LTE base stations is a handover target. If the handover occurs at which the LTE base station 10-1 is a handover source and the different LTE base station is a handover target, in Step S202 the hand-over-times acquisition unit 156 increments by one the number of handover source times in a record corresponding to the handover-target different LTE base station in the neighbor base-station priority table and updates a point thereof.

In Step S203, the hand-over-times acquisition unit 156 determines whether or not a handover occurs at which the different LTE base station is a handover source and the LTE base station 10-1 as its own LTE base station is a handover target. If the handover occurs at which the different LTE base station is a handover source and the LTE base station 10-1 is a handover target, in Step S204 the hand-over-times acquisition unit 156 increments by one the number of handover target times in a record corresponding to the different LTE base station as the handover source in the neighbor base-station priority table and updates a point thereof.

In Step S205, the hand-over-times acquisition unit 156 determines whether or not a handover request message transmitted from the radio terminal 40 is received at the handover at which the different LTE base station is a handover source and the LTE base station 10-1 is a handover target. If the handover request message is received, in Step S206 the hand-over-times acquisition unit 156 increments a value in the handover history by the number of Global-CIDs of the different LTE base station as the handover source, which are included in Global-CIDs included in the handover request message, and updates the point thereof.

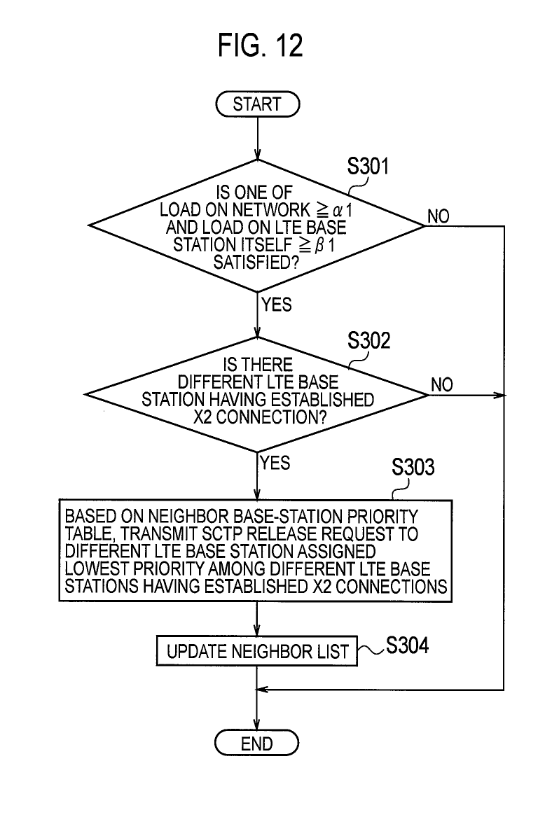

In parallel with the operation of acquiring the number of handovers shown in FIG. 11, an operation of controlling X2 connection release is performed. FIG. 12 is a flowchart showing the operation of controlling X2 connection release by the LTE base station 10-1.

In Step S301, the connection changing unit 158 in the controller 102 determines whether or not anyone of conditions that load on the backbone network 30 is equal to or higher than the predetermined value α1 and that load on the LTE base station 10-1 is equal to or higher than the predetermined value β1 is satisfied.

If any one of the conditions that the load on the backbone network 30 is equal to or higher than the predetermined value α1 and that the load on the LTE base station 10-1 is equal to or higher than the predetermined value β1 is satisfied, in Step S302 the connection changing unit 158 determines whether or not there is one or more different LTE base stations which have respective established X2 connections with the LTE base station 10-1.

If there is one or more different LTE base stations which have respective established X2 connections with the LTE base station 10-1, in Step S303 the connection changing unit 158 identifies, based on the neighbor base-station priority table, a different LTE base station which is assigned the lowest priority, in other words, which has the lowest point, among the different LTE base stations which have respective established X2 connections with the LTE base station 10-1. Further, the connection changing unit 158 transmits an SCTP release request message to the different LTE base station assigned the lowest priority.

In Step S304, the connection changing unit 158 updates X2 connection establishment information in the neighbor list corresponding to a Global-CID of the different LTE base station to which the SCTP release request message is transmitted, from “established” to “unestablished.”

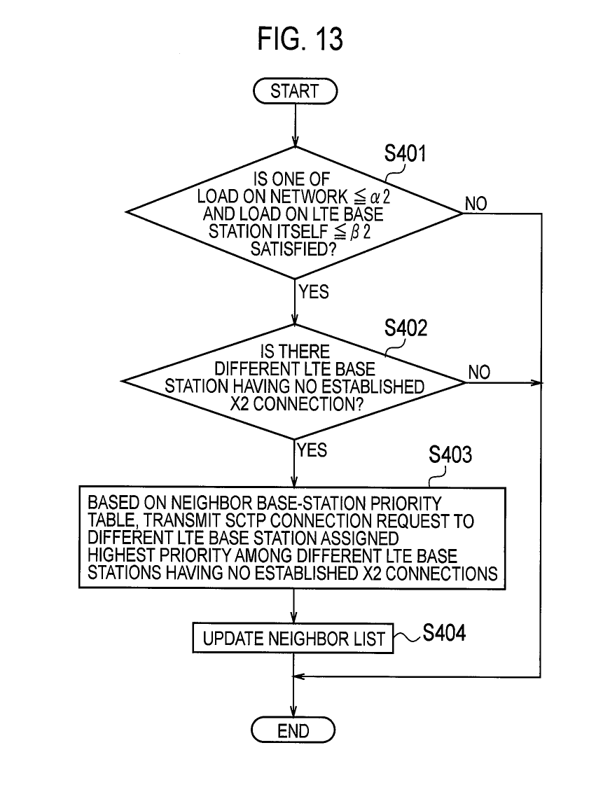

After the operation of controlling X2 connection release shown in FIG. 12, an operation of controlling X2 connection re-establishment is performed in parallel with the operation of acquiring the number of handovers shown in FIG. 11. FIG. 13 is a flowchart showing the operation of controlling X2 connection re-establishment by the LTE base station 10-1.

In Step S401, the connection changing unit 158 in the controller 102 determines whether or not anyone of conditions that load on the backbone network 30 is equal to or lower than the predetermined value α2 and that load on the LTE base station 10-1 is equal to or lower than the predetermined value β2 is satisfied.

If anyone of the conditions that the load on the backbone network 30 is equal to or lower than the predetermined value α2 and that the load on the LTE base station 10-1 is equal to or lower than the predetermined value β2 is satisfied, the connection changing unit 158 determines in Step S402 whether or not there is one or more different LTE base stations which have no established X2 connections with the LTE base station 10-1.

If there is one or more different LTE base stations which have no established X2 connections, in Step S403 the connection changing unit 158 identifies, based on the neighbor base-station priority table, a different LTE base station which is assigned the highest priority, in other words, which has the highest point, among the different LTE base stations which have no established X2 connections with the LTE base station 10-1. Further, the connection changing unit 158 transmits an SCTP connection request message to the different LTE base station assigned the highest priority.

In Step S404, the connection changing unit 158 updates X2 connection establishment information in the neighbor list corresponding to a Global-CID of the different LTE base station to which the SCTP connection request message is transmitted, from “unestablished” to “established.”

### (4) Advantageous Effects

As described above, in the radio communication system 1 according to the embodiment of the present invention, when the radio terminal 40 reaches trigger timing of a handover at which a handover source is the LTE base station 10-1 and a handover target is one of the different LTE base stations, the LTE base station 10-1 transmits an SCTP connection request message which is a request for establishing an X2 connection to the handover-target different LTE base station. Thus, an X2 connection can be established with past records of handovers taken into consideration, and an unnecessary X2 connection is prevented from being established with one of the different LTE base stations.

In addition, since an X2 connection is established with the past records of handovers taken into consideration, a maintenance person does not have to work to establish an optimum X2 connection as needed.

Moreover, in the radio communication system 1 according to the embodiment of the present invention, the LTE base station 10-1 acquires the number of handovers involving each one of the different LTE base stations. Specifically, the LTE base station 10-1 acquires the number of handovers at which the LTE base station 10-1 which is an LTE base station itself has been a handover source and the different LTE base station is a handover target, the number of handovers at which the different LTE base station has been a handover source and the LTE base station 10-1 which is the LIE base station itself is a handover target, and how many times the different LTE base station has been a connection target of the radio terminal 40 in the past, all of which are to be included in the neighbor base-station priority table.

Further, when any one of conditions that load on the backbone network 30 is equal to or higher than the predetermined value α1 and that load on the LTE base station 10-1 is equal to or higher than the predetermined value β1 is satisfied, the LTE base station 10-1 transmits an SCTP release request message to one of the different LTE base stations which is assigned the lowest priority determined according to the point in the neighbor base-station priority table, the different LTE base station being one of the different LTE base stations which have respective established X2 connections with the LTE base station 10-1. Thereby, the LTE base station 10-1 controls X2 connection release with the different LTE base station.

Still further, when any one of conditions that load on the backbone network 30 is equal to or lower than the predetermined value α2 and load on the LTE base station 10-1 is equal to or lower than the predetermined value β2 is satisfied, the LTE base station 10-1 transmits an SCTP connection request message to one of the different LTE base stations which is assigned the highest priority determined according to the point in the neighbor base-station priority table, the different LTE base station being one of the different LTE base stations which have no established X2 connections with the LTE base station 10-1. Thereby, the LTE base station 10-1 controls X2 connection re-establishment with the different LTE base station.

Thus, it is possible for the LTE base station 10-1: to release a second connection with one of the different LTE base stations having a small number of handovers involved therewith, when the load on the backbone network 30 and the load on the LTE base station itself are high and thus the X2 connection needs to be released; and to re-establish a second connection with one of the different LTE base stations having a large number of handovers involved therewith, when the load on the backbone network 30 and the load on the LTE base station itself are low and thus the X2 connection can be re-established. This makes it possible to establish an appropriate X2 connection with the load on the backbone network 30 and the LTE base station 10-1 taken into consideration.

### (5) Other Embodiment

As described above, the details of the present invention have been described by using the embodiment of the present invention. However, it should not be understood that the description and drawings which constitute part of this disclosure limit the present invention. From this disclosure, various alternative embodiments, examples, and operation techniques will be easily found by those skilled in the art.

In the aforementioned embodiment, the LTE base station 10-1 which is a handover source detects trigger timing of a handover of the radio terminal 40 and transmits an SCTP connection request message which is a request for establishing an X2 connection, to one of the different LTE base stations which is a handover target. However, the handover-target different LTE base station may detect the trigger timing of a handover of the radio terminal 40 and transmit an SCTP connection request message which is a request for establishing an X2 connection, to the LTE base station 10-1 of the handover source.

In addition, when a handover does not occur between the LTE base station 10-1 and one of the different LTE base stations even though a predetermined time passes after an X2 connection is established between the LTE base station 10-1 and the different LTE base station, the controller 102 in the LTE base station 10-1 may perform processing of releasing the X2 connection between the LTE base station 10-1 and the different LTE base station. In this case, after the X2 connection is released, the controller 102 updates X2 connection establishment information in the neighbor list corresponding to a Global-CID of the different LTE base station, from “established” to “unestablished.” Alternatively, after the X2 connection is released, the controller 102 deletes the Global-CID and the X2 connection establishment information of the different LTE base station in the neighbor list.

Moreover, a measurement report may include not only a Phy-CID and a field intensity but also a state of load on a CPU of an LTE base station corresponding to the Phy-CID and a state of load on a radio channel thereof. In this case, the controller 102 can identify an LTE base station to be a handover target in consideration of not only the field intensity but also the state of the load on the CPU of the LTE base station and the state of the load on the radio channel.

In this case, it is possible to establish an X2 connection with the state of the load on the CPU of the LTE base station and the state of the load on the radio channel taken into consideration.

In the aforementioned embodiment, the LTE base station 10-1 transmits an SCTP release request message to one of the different LTE base stations which is assigned the lowest priority to control X2 connection release with the different LTE base station, and transmits an SCTP connection request message to one of the different LTE base stations which is assigned the highest priority to control X2 connection re-establishment with the different LTE base station.

However, the LTE base station 10-1 may transmit an SCTP release request message to a predetermined number of different LTE base stations which are assigned lower priorities to control X2 connection release with the different LTE base stations. In addition, the LTE base station 10-1 may transmit an SCTP connection request message to a predetermined number of different LTE base stations which are assigned higher priorities to control X2 connection re-establishment with the different LTE base stations.

Moreover, in the aforementioned embodiment, the LTE base station 10-1 performs control of the X2 connection release when the load on the backbone network 30 and the load on the LTE base station itself are high, and performs control of the X2 connection re-establishment when the load on the backbone network 30 and the load on the LTE base station itself are low.

In addition to such control of the X2 connection establishment, the LTE base station 10-1 may further perform the control of the X2 connection release with one of the different LTE base stations when the load on the different LTE base station is high, and may further perform the control of the X2 connection re-establishment with the different LTE base station when the load on the different LTE base station is low.

In this case, the connection changing unit 158 in the controller 102 receives information on the load on the different LTE base station transmitted from the different LTE base station, through the backbone network 30 and the I/F unit 104. The load on the different LTE base station is expressed, for example, as an activity ratio of the CPU included in the controller 102.

Further, when the load on the different LTE base station is equal to or higher than a predetermined value γ1 and when an X2 connection is established with the different LTE base station, the connection changing unit 158 transmits an SCTP release request message to the different LTE base station to control the X2 connection release.

Still further, when the load on the different LTE base station is equal to or lower than a predetermined value γ2 (however, γ2≦γ1) and when an X2 connection is not established with the different LTE base station, the connection changing unit 158 transmits an SCTP connection request message to the different LTE base station to control the X2 connection re-establishment.

Meanwhile, the description has been given of the radio communication system 1 based on the LTE. However, the present invention is applicable to any radio communication system likewise, as long as a logical transmission path is established between radio base stations in the radio communication system.

As described above, it should be understood that the present invention includes various embodiments which are not described herein. Accordingly, the present invention should be determined only by the matters to define the invention in the scope of claims regarded as appropriate based on the disclosure.

Note that the entire contents of Japanese Patent Application No. 2009-107091 (filed on Apr. 24, 2009) and Japanese Patent Application No. 2009-107094 (filed on Apr. 24, 2009) are incorporated herein by reference.

### INDUSTRIAL APPLICABILITY

The radio base station and the method for controlling connection establishment are capable of establishing an appropriate connection with a different radio base station and are useful as a radio base station and a method for controlling connection establishment.

1. A radio base station capable of establishing a first connection which is a logical transmission path with a higher network and a second connection which is a logical transmission path with a different radio base station, the radio base station comprising:
a transmitter configured to transmit a request message for establishing the second connection, to the different radio base station which is a handover target or a handover source, wherein
when the radio base station executes a handover, the transmitter transmits the request message.

2. The radio base station according to claim 1, wherein
the transmitter transmits the request message when the second connection is not established with the different radio base station which is the handover target or the handover source.

3. The radio base station according to claim 2, further comprising
a holding unit configured to hold information on the different radio base station, wherein
based on the information on the different radio base station held in the holding unit, the transmitter determines whether or not the second connection is established with the different radio base station which is the handover target or the handover source.

4. The radio base station according to claim 3, wherein
the information on the different radio base station includes identification information of the different radio base station.

5. The radio base station according to claim 1,
wherein the transmitter transmits the request message when the handover of a radio terminal is completed.

6. The radio base station according to claim 1, comprising
a storage unit configured to store identification information of a different radio base station which has been a handover target at a handover where the radio base station itself has been a handover source in the past, and store establishment information indicating whether or not the second connection is established between the radio base station itself and the different base radio station of the handover target.

7. A connection establishment control method in a radio base station capable of establishing a first connection which is a logical transmission path with a higher network and a second connection which is a logical transmission path with a different radio base station, the connection establishment control method comprising the step of
transmitting a request message for establishing the second connection, from the radio base station to the different radio base station which is a handover target or a handover source, when the radio base station executes a handover.

8. A radio base station capable of establishing a first connection which is a logical transmission path with a higher network and a second connection which is a logical transmission path with any one of different radio base stations, the radio base station comprising:
a connection changing unit configured to control release and/or re-establishment of the second connection with the different radio base station based on the number of handovers involving the different radio base station.

9. The radio base station according to claim 8, wherein the number of handovers is the number of handovers between the radio base station itself and the different radio base station and/or the number of past handovers of a radio terminal to the radio base station itself as a handover target.

10. The radio base station according to claim 8, wherein the connection changing unit releases the second connections with a predetermined first number of radio base stations in ascending order of priority determined according to the number of handovers, among the different radio base stations.

11. The radio base station according to claim 10, wherein the connection changing unit releases the second connection in at least one of cases where load on a network between the radio base station itself and the different radio base stations is equal to or higher than a first predetermined value, where load on the radio base station itself is equal to or higher than a second predetermined value, and where load on the different radio base stations is equal to or higher than a third predetermined value.

12. The radio base station according to claim 8, wherein the connection changing unit re-establishes the second connections with a predetermined second number of radio base stations in descending order of priority determined according to the number of handovers, among the different radio base stations.

13. The radio base station according to claim 12, wherein the connection changing unit re-establishes the second connection in at least one of cases where load on a network between the radio base station itself and the different radio base stations is equal to or lower than a fourth predetermined value, where load on the radio base station itself is equal to or lower than a fifth predetermined value, and where load on the different radio base stations is equal to or lower than a sixth predetermined value.

14. A connection establishment control method in a radio base station capable of establishing a first connection which is a logical transmission path with a higher network and a second connection which is a logical transmission path with any one of different radio base stations, the connection establishment control method comprising the steps of:
acquiring, by the radio base station, the number of handovers involving the different radio base station; and
controlling, by the radio base station, release and/or re-establishment of the second connection with the different radio base station, on the basis of the acquired number of handovers.
